(19) United States
(12) Patent Application Publication
(10) Pub. No.: US 2006/0062311 A1
(43) Pub. Date: Mar. 23, 2006

(54) Graceful degradation of loop filter for real-time video decoder

(75) Inventors: Shijun Sun, Vancouver, WA (US); Quan Li, Vancouver, WA (US)

Correspondence Address: SHARP LABORATORIES OF AMERICA, INC, 5750 NW PACIFIC RIM BLVD, CAMAS, WA, 98642, US

(73) Assignee: Sharp Laboratories of America, Inc.

(21) Appl. No.: 10/945,599

(22) Filed: Sep. 20, 2004

(51) Int. Cl. H04N 11/04; H04N 7/12; H04N 11/02; H04B 1/66

(52) U.S. Cl. 375/240.24; 375/240.25; 375/240.12

(57) ABSTRACT

A deblocking filtering technique gracefully degrades the quality of a decoded video image by selecting boundaries in each macroblock (MB) of the video image that are not to be filtered in response to a predetermined condition. The predetermined condition could be that the video image cannot be decoded by a predetermined time indicated by a time code contained in the bitstream, a manual indication by one of a user and an application, a decoder configuration having insufficient computational power to correctly decode the video image and/or a near buffer overflow condition. When a predetermined condition occurs, a coded-block-pattern parameter for each inter-coded macroblock of the bitstream is set to zero for filtering. A boundary strength is derived for each macroblock based the coded-block-pattern parameters for the macroblock. Each macroblock is filtered based on the boundary strength for the macroblock.

### BACKGROUND OF THE INVENTION

1. Field of the Invention

The present invention relates to data decompression techniques. In particular, the present invention relates to a system and a method for decoding a video image with a filter having a reduced computational complexity that does not significantly degrade the video quality of the decoded video image.

2. Description of the Related Art

Advances of video coding and communication techniques have in recent years enabled many video-streaming applications. In order to decode some portions of streaming-video signals, a codec having a high computational power is necessary and which can be difficult to implement by a Digital Signal Processor (DSP). In particular, when the decoding process is not sufficiently fast, particularly for difficult or complex bitstreams, it becomes necessary to omit part of the decoding process, but keep a reasonable video quality for the portion of the bitstream that is decoded. For a typical H.264 decoder, the filtering calculation of the decoding process consumes more than 50% of the instruction cycles of the DSP. A straightforward technique for reducing decoding complexity would be to omit the entire filtering process when there is insufficient CPU cycles available in order to display a video image correctly. Such an approach, however, usually leaves significant visible artifacts particularly when errors propagate through a video sequence.

Consequently, what is needed is a technique for using a DSP for implementing a decoder, such as an H.264 decoder, with a filter having a reduced computational complexity that does not significantly degrade the video quality of a decoded video image.

### SUMMARY OF THE INVENTION

The present invention provides a technique for using a DSP for implementing a decoder, such as an H.264 decoder, with a filter having a reduced computational complexity that does not significantly degrade the video quality of a decoded video image. In particular, the present invention provides a filtering process having a reduced computational complexity that gracefully degrades a decoded video image when, for example, there is insufficient CPU cycles available in order to display the video image correctly. Accordingly, the technique of the present invention is well suited for real-time hardware implementation.

The advantages of the present invention are provided by a method for decoding a bitstream containing a plurality of macroblocks forming a video image. The bitstream can be an H.264 compliant bitstream. Alternatively, the bitstream can be an H.264-based bitstream. When a predetermined condition occurs, a coded-block-pattern parameter for each inter-coded macroblock of the bitstream is set to zero for filtering. The predetermined condition could be that the video image cannot be decoded by a predetermined time indicated by a time code contained in the bitstream, a manual indication by one of a user and an application, a decoder configuration having insufficient computational power to correctly decode the video image and/or a near buffer overflow condition. A boundary strength is derived for each macroblock based the coded-block-pattern parameters for the macroblock. Each macroblock is filtered based on the boundary strength for the macroblock

The present invention also provides a system that includes a processor and a deblocking filter. The processor processes a bitstream containing a plurality of macroblocks forming a video image. The bitstream could be an H.264 compliant bitstream. Alternatively, the bitstream could be an H.264-based bitstream. The processor sets a coded-block-pattern parameter for each inter-coded macroblock of the bitstream to zero for filtering based on a predetermined condition. The predetermined condition could be that the video image cannot be decoded by a predetermined time indicated by a time code contained in the bitstream, a manual indication by one of a user and an application, a decoder configuration having insufficient computational power to correctly decode the video image and/or a near buffer overflow condition. The processor derives a boundary strength for each macroblock based the coded-block-pattern parameters for the macroblock. The deblocking filter filters the macroblock based on the boundary strength for the macroblock.

In one exemplary embodiment, the processor includes a shared data buffer, a message buffer, a general-purpose processor and a digital signal processor. The shared data buffer contains macroblocks forming the video image. The message buffer contains processing messages. The general-purpose processor entropy decodes the macroblocks contained in the shared data buffer and stores a processing message in the message buffer relating to each set of macroblocks contained in the shared data buffer that are ready for reconstruction. The digital signal processor reconstructs macroblocks contained in the shared data buffer that have been indicated as ready for reconstruction in response to a processing message. The near buffer overflow condition occurs when the message buffer is a predetermined percentage full, such as about 95% full.

### BRIEF DESCRIPTION OF THE DRAWINGS

The present invention is illustrated by way of example and not by limitation in the accompanying figures in which like reference numerals indicate similar elements and in which:

FIG. 1 depicts a functional block diagram of an exemplary decoder having an H.264 baseline profile;

FIG. 2 depicts a flow diagram of a process for filtering macroblocks with graceful degradation according to the present invention; and

FIG. 3 shows a functional block diagram of an exemplary architecture of a decoder according to the present invention.

### DETAILED DESCRIPTION OF THE PRESENT INVENTION

The present invention provides a filtering technique for a decoder, such as an H.264 decoder, that when enabled gracefully degrades the quality of a decoded video image when, for example, there is insufficient CPU cycles available in order to display the video image correctly. That is, the filtering technique of the present invention provides a reduced computational complexity in comparison to conventional filtering techniques by selecting boundaries in each macroblock (MB) of the video image that are not to be filtered.

In one exemplary embodiment, the present invention detects when the decoder is operating too slowly in order to display a frame based on the time code associated with the frame and enables a graceful-degradation filter (GDF) to gracefully degrade the quality of a decoded video image. In another exemplary embodiment, the GDF of the present invention is enabled manually by, for example, a user or by an application. In still another exemplary embodiment, the GDF of the present invention is enabled based on an implementation configuration decoder configuration, such as a decoder having insufficient computational power to correctly decode a video image. In yet another exemplary embodiment, the graceful-degradation filter (GDF) of the present invention is enabled based on a near buffer overflow condition that occurs during the decoding process.

The graceful degradation filter (GDF) of the present invention can eliminate a significant portion of the filtering operation during macroblock reconstruction, thereby saving up to about 20% of the overall decoding process and while retaining reasonable quality for decoded video images. Moreover, the GDF of the present invention makes real-time implementation of a decoder by a DSP possible

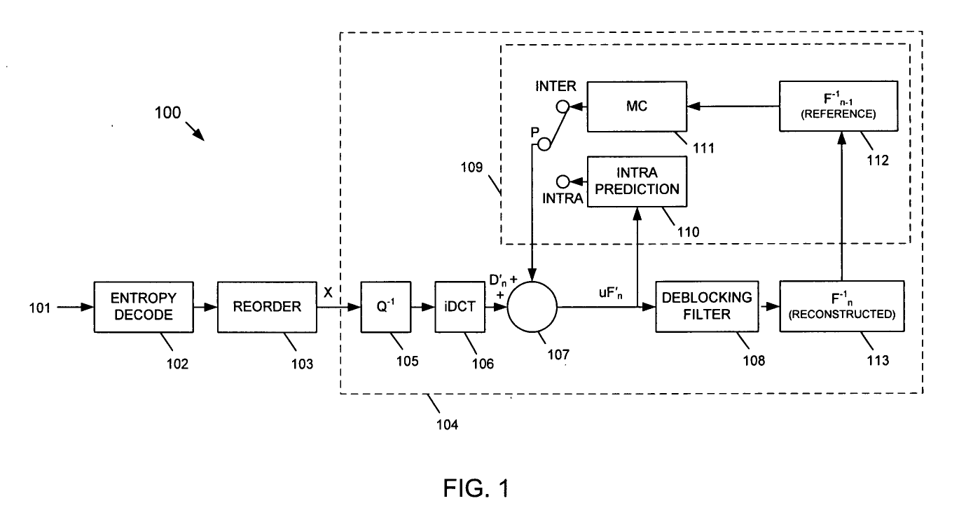

FIG. 1 depicts a functional block diagram of an exemplary decoder 100 having an H.264 baseline profile. Decoder 100 includes an entropy decoder 102, a reorderer 103 and an MB reconstruction module 104. MB Reconstruction module 104 includes a dequantizer (Q⁻¹) 105, an inverse Discrete Cosine Transformer (iDCT) 106, a summer 107, a deblocking filter 108, and an intra/inter prediction module 109. Intra/inter prediction module 109 includes intra prediction 110 and motion compensation (MC) 111 on a reference frame F⁻¹ₙ₋.

In FIG. 1, entropy decoder 102 receives a compressed bitstream 101 from the Network Abstraction Layer (NAL). When bitstream 101 is an H.264 compliant bitstream, bitstream 101 includes information for decoding a picture, or frame, which is partitioned into one or more slices, such that each slice includes, for example, a sequence of 16×16 macroblocks (MBs) in a raster-scan order. Entropy decoder 102 entropy decodes bitstream 101. The entropy-decoded bitstream is reordered by reorderer 103 to produce a set of quantized coefficients X. Quantized coefficients X are rescaled at dequantizer (Q⁻¹) 105 and inverse transformed at iDCT 106 to generate D′ₙ. Header information within bitstream 101 is used to generate a prediction MB P, which is based on either intra prediction 110 or a reference frame F⁻¹ₙ₋₁ 112 that has been motion compensated (MC) at 111. Prediction MB P is added to D′ₙ to generate unfiltered MB uF′ₙ. Unfiltered MB uF′ₙ is filtered at 108 to form decoded macroblock F′ₙ 113.

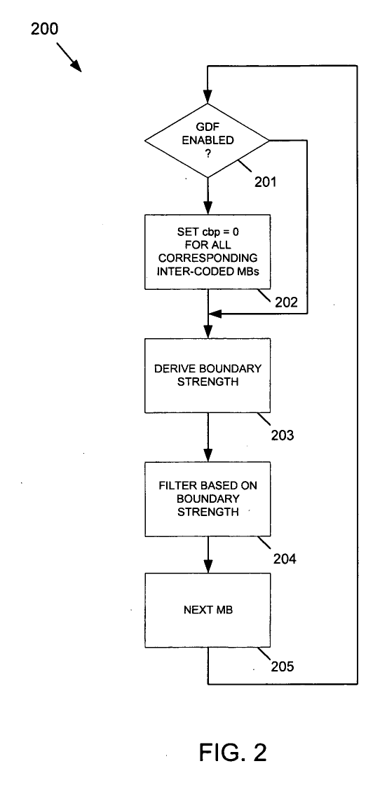

FIG. 2 depicts a flow diagram 200 of a process for filtering macroblocks with graceful degradation according to the present invention. At step 201, it is determined whether the graceful-degradation filter (GDF) of the present invention has been enabled. The GDF of the present invention can be enabled in one or a combination of several ways. In one exemplary embodiment, the GDF of the present invention is enabled when the decoder is detected as operating too slowly in order to display a frame based on the time code associated with the frame. In another exemplary embodiment, the GDF of the present invention is enabled manually by, for example, a user or an application. In still another exemplary embodiment, the GDF of the present invention is enabled based on a decoder configuration. In yet another exemplary embodiment, the graceful-degradation filter (GDF) of the present invention is enabled based on a near buffer overflow condition that occurs during the decoding process. Accordingly, the GDF could be enabled by a combination of two or more of the foregoing ways that the GDF could be enabled.

If, at step 201, the GDF of the present invention has not been enabled, flow continues to step 203. If, at step 201, the GDF of the present invention has been enabled, flow continues to step 202 where the cbp (coded-block-pattern) parameter for all inter-coded macroblocks is set to zero after macroblock reconstruction before filtering. Alternatively, because the cbp parameter is useful for other purposes during the decoding operation, a copy of the cbp parameter for each macroblock could be created and used for filtering purposes. The copy of the cbp parameter for a macroblock could be set to zero when the GDF of the present invention is enabled. The copy of the cbp parameter is then used for filtering. When the GDF of the present invention is not enabled the original and copy of the cbp parameter for a macroblock will be identical and either version of the cbp parameter could be used for filtering. Flow continues to step 203.

At step 203, the boundary strength for a macroblock is derived in a well-known manner based on the macroblock coding mode, motion vectors, reference pictures, and cbp parameters. When the GDF of the present invention is not enabled, that is under normal conditions, boundary strength values range from 0 to 4. For instance, boundary strength is 4 or 3 when one of the two blocks along a block boundary in a macroblock is intra-coded. Boundary strength is 2 when one of blocks along a block boundary has a non-zero cbp parameter. Boundary strength is 1 when the motion vectors of the blocks along a block boundary are not very close to each other or the reference pictures are different, otherwise boundary strength is set to be zero.

When the GDF filter of the present invention is enabled, boundary strength derivation at step 203 is identical, except that the cbp parameter for the macroblock is set to zero after macroblock reconstruction before filtering. Consequently, some of the boundaries in the macroblock, which would have been filtered using a boundary strength of 2 if the GDF filter were not enabled, are treated in one of two ways. In the first way, areas having discontinued motions are filtered using boundary strength 1, which is not as strong as would have been filtered if the GDF filter of the present invention were not enabled. In the second way, areas having smooth motions are not filtered. Accordingly, the GDF of the present invention does not introduce any difference to intra-coded regions. Limited errors are introduced along some inter-coded macroblock boundaries. For most internal boundaries within the macroblock in which motions are smooth or uniform and in which even normal filtering would not be strong, filtering by the GDF of the present invention is omitted.

Flow continues to step 204, where MB is filtered by filter 108 based on the boundary strength derived in step 203. The higher the boundary strength value, the stronger the filtering operation performed by filter 108. When the boundary strength equals to zero, the filter operation is not needed and is omitted. Changing only the cbp parameter for each macroblock enables all the computational savings provided by the present invention. No changes are required for deblocking filter 108. Moreover, because filtering is performed at the macroblock level instead of at the picture level, the costs associated with filtering reconstructed pixels are eliminated.

Flow continues to step 205 where the next MB is considered for reconstruction and flow returns to step 201.

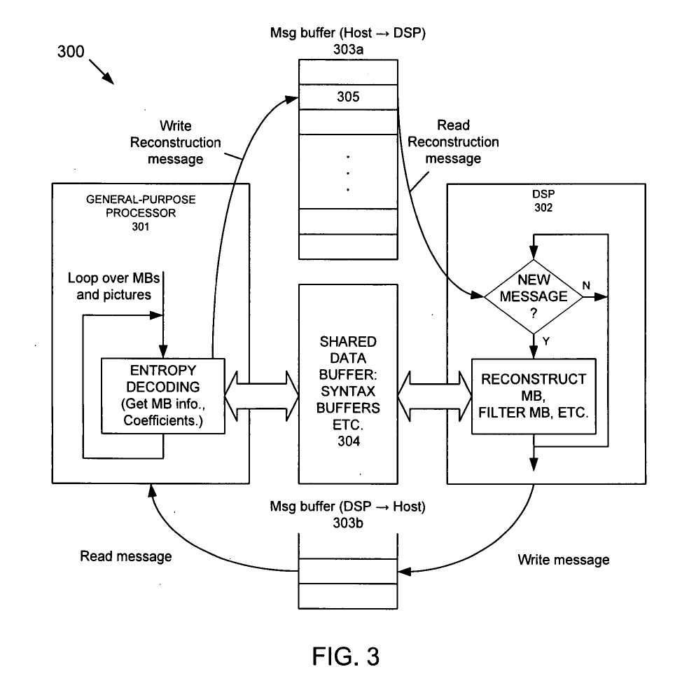

FIG. 3 shows a functional block diagram of an exemplary architecture of a decoder 300 according to the present invention. Decoder 300 includes a general-purpose processor 301 and a Digital Signal Processor (DSP) 302. Video decoding tasks are divided between processor 301 and DSP 302 to provide load balancing. Entropy decoding is performed on general-purpose processor 301 and macroblock reconstruction and deblocking filtering are performed on DSP 302. In the configuration shown in FIG. 3, processor 301 acts as a host processor.

Processor 301 and DSP 302 communicate through a low-overhead message system using, for example, a small on-chip buffer that includes a message buffer (Host→DSP) 303a, a message buffer (DSP→Host) 303b, and a shared data buffer 304. The message system enables highly asynchronous parallel operations between processor 301 and DSP 302 and allows a trade-off between memory use and depth of piplining. Message buffer 303 is used for communication and directing access to shared data buffer 304. Shared data buffer 304 contains information needed for reconstructing each macroblock. Message content specifies the range of macroblocks that are ready for reconstruction. Shared data buffer 304 generally contains decoded information for each macroblock that is to be reconstructed for several frames. Nevertheless, extremely deep pipelines, i.e., several thousand macroblocks, could be used for balancing the variation of processing between processor 301 and DSP 302. Consequently, neither processor impedes the progress of the other, thereby providing significant system performance improvement in contrast to a conventional interrupt-based messaging technique. Moreover, the overhead of the messaging system is negligible, the number of messages for each frame is extremely small. Even when extremely deep pipelining is used, typically only one message is sent per macroblock row. Alternatively, one message could be sent per slice or per frame

Message buffer 303 could be embodied as a memory that is internal to an integrated circuit implementing general-purpose processor 301 and DSP 302 together, while shared data buffer 304 could be a large, shared memory space that is external to processor 301 and DSP 302. For example, in one exemplary embodiment, message buffer 303 is only 256 words, or 512 bytes, in size while shared data buffer 304 approximately 5.4 Mbytes in size.

Processor 301 maintains an index to a frame of macroblocks info in shared data buffer 304. As processor 301 entropy decodes a frame, the resulting information is placed in shared data buffer 304. Subsequent to entropy decoding, processor 301 sends, or writes, a reconstruction message (illustrated by exemplary message 305) to DSP 302 by writing a reconstruction message in message buffer 303a. Subsequently, processor 301 no longer accesses the portion of shared data buffer 304 corresponding to the reconstruction message until DSP 302 processes the reconstruction message.

Because macroblocks are processed in groups, for example, rows or frames, the MB information data flow can be pipelined with other DSP operations. For example, while DSP 302 is filtering one macroblock, a DMA engine (not shown in FIG. 3) can load macroblock information into shared data buffer 304 for reconstruction of the next macroblock. Thus, in most cases, the macroblock information is already in shared data buffer 304 when DSP 302 is ready to process the macroblock information.

Message read and write operations are managed through a host_write_index and a dsp_read_index. Initially, both of the host_write_index and the dsp_read_index are set to 0. Both indices are stored in a known location in shared data buffer 304, so that both processor 301 and DSP 302 can monitor the respective indices. After processor 301 writes a message, processor 301 updates the host_write_index. DSP 302 continually checks the host_write_index to determine whether processor 301 has written a new message. When DSP 302 determines that a new message has been written, DSP 302 reads and processes the message. DSP 302 then updates the dsp_read_index. A similar set of indices (dsp_write_index and host_read_index) is used for messages sent from DSP 302 to processor 301.

When DSP 302 detects whether the reconstruction messages have almost filled message buffer 303a, i.e., a near overflow condition, the graceful degradation filter of the present invention is enabled. The determination is made dynamically based on the message buffer status when each message is retrieved. The threshold or degree of fullness of message buffer 303a that causes DSP 302 to detect a near overflow condition could be, for example, about 95% full, but will vary with implementation. In response to a detected near overflow condition, the GDF of the present invention is enabled and the cbp parameter for each subsequent inter-coded macroblock that is reconstructed is set to zero after macroblock reconstruction before filtering. The GDF of the present invention remains enabled until message buffer 303a the degree of fullness of message buffer 303a falls below a defined threshold, such as about 75% full. The threshold for disabling the GDF of the present invention will also vary with implementation. Alternatively or in addition, the GDF of the present invention could be enabled manually by, lo for example, a user or by an application.

Although the foregoing invention has been described in some detail for purposes of clarity of understanding, it will be apparent that certain changes and modifications may be practiced that are within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for decoding a bitstream containing a plurality of macroblocks forming a video image, the method comprising:
setting a coded-block-pattern parameter for each inter-coded macroblock of the bitstream to zero for filtering based on a predetermined condition;
deriving a boundary strength for each macroblock based the coded-block-pattern parameters for the macroblock; and
filtering each macroblock based on the boundary strength for the macroblock.

2. The method according to claim 1, wherein the predetermined condition is that the video image cannot be decoded by a predetermined time indicated by a time code contained in the bitstream.

3. The method according to claim 1, wherein the predetermined condition is a manual indication by one of a user and an application.

4. The method according to claim 1, wherein the predetermined condition is a decoder configuration having insufficient computational power to correctly decode the video image.

5. The method according to claim 1, wherein the predetermined condition is a near buffer overflow condition.

6. The method according to claim 1, wherein the bitstream is an H.264 compliant bitstream.

7. The method according to claim 1, wherein the bitstream is an H.264-based bitstream.

8. A system, comprising:
a processor processing a bitstream containing a plurality of macroblocks forming a video image, the processor setting a coded-block-pattern parameter for each inter-coded macroblock of the bitstream to zero for filtering based on a predetermined condition and deriving a boundary strength for each macroblock based the coded-block-pattern parameters for the macroblock; and
deblocking filter filtering each macroblock based on the boundary strength for the macroblock.

9. The system according to claim 8, wherein the predetermined condition is that the video image cannot be decoded by a predetermined time indicated by a time code contained in the bitstream.

10. The system according to claim 8, wherein the predetermined condition is a manual indication by one of a user and an application.

11. The system according to claim 8, wherein the predetermined condition is a decoder configuration having insufficient computational power to correctly decode the video image.

12. The system according to claim 8, wherein the predetermined condition is a near buffer overflow condition.

13. The system according to claim 12, wherein the processor includes:
a shared data buffer contained macroblocks forming the video image;
a message buffer containing processing messages;
a general-purpose processor entropy decoding the macroblocks contained in the shared data buffer, the general-purpose processor storing a processing message in the message buffer relating to each set of macroblocks contained in the shared data buffer that are ready for reconstruction; and
a digital signal processor reconstructing macroblocks contained in the shared data buffer that have been indicated as ready for reconstruction in response to a processing message,
the near buffer overflow condition occurring when the message buffer is a predetermined percentage full.

14. The system according to claim 13, wherein the predetermined percentage is about 95%.

15. The system according to claim 8, wherein the bitstream is an H.264 compliant bitstream.

16. The system according to claim 8, wherein the bitstream is an H.264 -based bitstream.
